(19) United States
(12) Patent Application Publication
(10) Pub. No.: US 2007/0162863 A1
(43) Pub. Date: Jul. 12, 2007

(54) Three dimensional virtual pointer apparatus and method

(76) Inventors: Eric R. Buhrke, Clarendon Hills, IL (US); Mark A. Tarlton, Barrington, IL (US); George T. Valliath, Winnetka, IL (US); Julius S. Gyorfi, Vernon Hills, IL (US); Juan M. Lopez, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/327,558

(22) Filed: Jan. 6, 2006

(51) Int. Cl. G06F 3/048

(52) U.S. Cl. 715/757; 715/857; 715/706

(57) ABSTRACT

A selectable three dimensional virtual pointer (501) that can be selected by a collaborator and displayed within a virtual collaboration environment (200) as being sourced by an avatar (202) that corresponds to the collaborator who selected the pointer. This pointer can be used, for example, to point towards a given object (205) within the virtual collaboration environment. So configured, in a preferred approach this orientation with respect to source and target persists regardless of which collaborator views the pointer (and hence the perspective view of the pointer varies with respect to the viewer in order to ensure this orientation).

### TECHNICAL FIELD

This invention relates generally to virtual collaboration environments and more particularly to virtual collaboration environments that support avatar and object usage.

### BACKGROUND

Various virtual collaboration environments are known in the art. Such environments typically serve to permit a group of individuals who share a similar interest, goal, task, or the like to collaborate with one another. Such an environment may be represented, for example, by a virtual context that places avatars for at least some of these collaborators in a shared virtual space such as a virtual meeting room or the like.

As noted, by one approach this virtual collaboration environment can be populated by one or more avatars (i.e., virtual entities that represent a given corresponding collaborator and/or other entity such as an expert system or the like). So configured, an individual viewing the virtual collaboration environment will typically see, within the virtual collaboration environment, one or more avatars as stand-ins for the other entities that are present in the collaboration environment and that are presumably available to collaborate via, for example, text and/or audible communications, document sharing, and so forth.

By one approach this virtual collaboration environment can also support inclusion of one or more objects. While such an object can comprise, for example, an avatar itself, such objects can be considerably more varied. Illustrative examples might include a building model being discussed by a group of physically separated architects, a new product design being reviewed by a physically separated design team, or a virtual rendering of a diseased human organ being studied and diagnosed by a physically separated medical services team, to name but a few.

The availability and use of such avatars and objects within the context of a virtual collaboration environment can greatly facilitate and enrich the collaboration activity. These elements can also lead to ambiguity, miscommunications, and errors in understanding, however. For example, various participants may become confused regarding the particular object being referred to by a given collaborator/avatar. Such confusion can become more acute as the number of objects and/or avatars increases. These problems can become even more pronounced when the virtual collaboration environment comprises a three dimensional construct where each participant has a corresponding differing view of the environment itself.

### BRIEF DESCRIPTION OF THE DRAWINGS

The above needs are at least partially met through provision of the three dimensional virtual pointer apparatus and method described in the following detailed description, particularly when studied in conjunction with the drawings, wherein:

FIG. 1 comprises a flow diagram as configured in accordance with various embodiments of the invention;

FIG. 2 comprises a prior art view of a display of a virtual collaboration environment;

FIG. 3 comprises a prior art view of a display of a virtual collaboration environment;

FIG. 4 comprises a schematic view of a plurality of illustrative pointers as configured in accordance with various embodiments of the invention;

FIG. 5 comprises a display of a virtual collaboration environment as configured in accordance with various embodiments of the invention;

FIG. 6 comprises a display of a virtual collaboration environment as configured in accordance with various embodiments of the invention;

FIG. 7 comprises a display of a virtual collaboration environment as configured in accordance with various embodiments of the invention;

FIG. 8 comprises a display of a virtual collaboration environment as configured in accordance with various embodiments of the invention;

FIG. 9 comprises a display of a virtual collaboration environment as configured in accordance with various embodiments of the invention; and

FIG. 10 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, these various embodiments are suitable for use with a virtual collaboration environment having a plurality of participating avatars representing participants at a plurality of locations with each avatar being displayed in its respective environmental perspective and each participant viewing the virtual collaboration environment from the unique perspective as corresponds to its particular avatar. The virtual collaboration environment may also include one or more objects (which object may comprise an avatar or other item of interest). (Those skilled in the art will recognize and understand that such avatars and objects, though possibly representing real-world counterparts, are themselves virtual as well as the environment within which they are presented.)

Still speaking generally, these teachings provide for a selectable three dimensional virtual pointer that can be selected by one of the collaborators and displayed as being sourced by the avatar which corresponds to the collaborator who selected the pointer. This pointer can be used, for example, to point towards a given object within the virtual collaboration environment. So configured, by one approach this orientation with respect to source and target persists regardless of which collaborator views the pointer (and hence the perspective view of the pointer varies with respect to the viewer in order to ensure this orientation).

So configured, communications amongst a plurality of collaborators using a virtual collaboration environment are considerably enhanced. Ambiguity regarding the topic of a given collaborator's comments and/or which collaborator is making a present point can be greatly reduced by application of these teachings. As will be shown herein the use of such a pointer can be rendered relatively easy and even intuitive. It will also be shown that a plurality of such pointers are readily accommodated if desired.

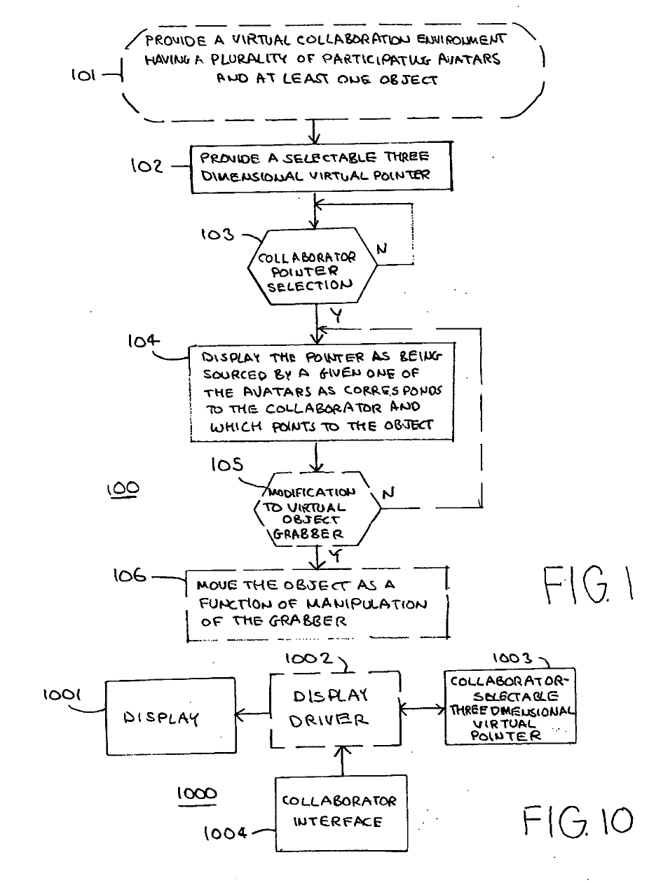

These and other benefits may become clearer upon making a thorough review and study of the following detailed description. Referring now to the drawings, and in particular to FIG. 1, a corresponding process 100 will typically serve in conjunction with the provision 101 of a virtual collaboration environment having a plurality of participating avatars that represent corresponding participants who are located at a plurality of (likely disparate) locations and at least one object (which object may comprise an avatar or other item of interest). To illustrate, and referring momentarily to FIG. 2, a given display of a virtual collaboration environment 200 may support (in this example) four collaborators 201. These collaborators 201 include, in this illustrative example, two avatars 202 and 204 who are represented as persons sitting at a table and a third avatar 203 represented as an image on a virtual video display (those skilled in the art will understand that this view of the virtual collaboration environment 200 represents the viewpoint of the fourth collaborator and hence the latter is not directly visible in this view). It may also be noted that such a virtual collaboration environment 200 may also feature one or more objects 205 (with only one being shown in this example for simplicity and clarity).

By a typical approach each participant views the virtual collaboration environment 200 from the unique perspective of its respective avatar. To illustrate, and referring now momentarily to FIG. 3, when viewing the virtual collaboration environment 200 from the perspective of the first avatar 202, the fourth avatar 301 now becomes visible in the field of view and the first avatar 202, of course, is removed from the field of view. Those skilled in the art will also understand and appreciate that the various avatars, objects, and other elements of the virtual collaboration environment 200 are all turned and moved as appropriate to ensure that the view of each avatar comprises a unique and appropriate view that accords with the respective position of the viewing avatar. Virtual collaboration environments are known generally in the art as are techniques and methods to establish the aforementioned points-of-view for participating avatars. As these teachings are not particularly sensitive to the selection of any particular approach to accomplishing the foregoing, and further for the sake of brevity and the preservation of narrative focus, further elaboration regarding such virtual collaboration environments will not be provided here.

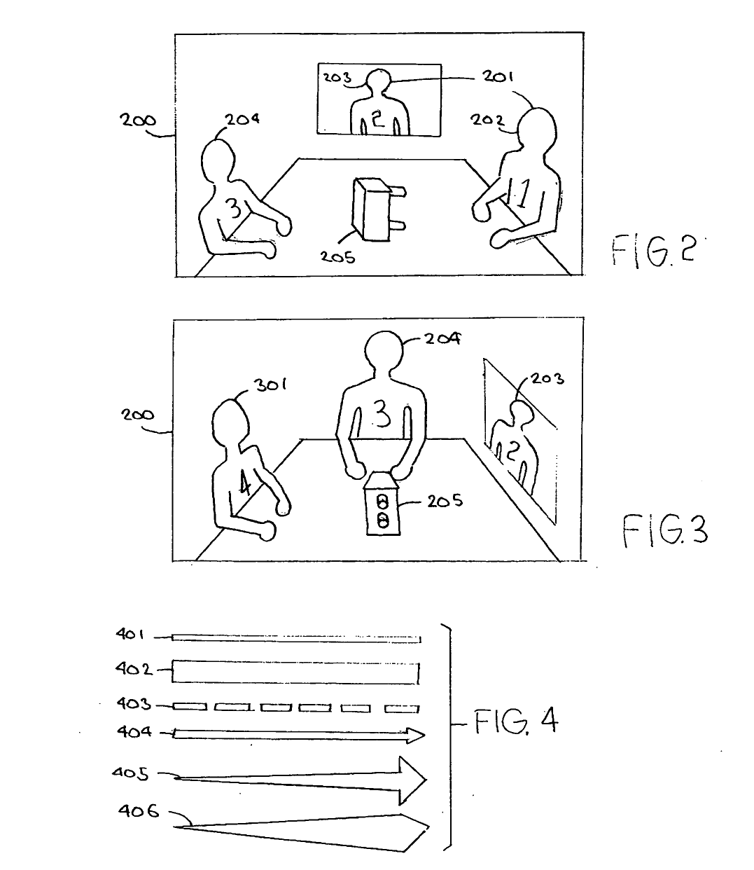

Referring again to FIG. 1, this process 100 provides 102 a selectable three dimensional virtual pointer (and can provide a plurality of selectable three dimensional virtual pointers). The three dimensional virtual pointer (or pointers) can assume any of a wide variety of form factors. A few illustrative examples are presented in FIG. 4. The illustrated examples include a relatively thin substantially linear pointer 401, a relatively thick substantially linear pointer 402, a dashed line pointer 403, and a number of pointers 404-406 having a substantially arrow-shaped form factor. When providing a plurality of virtual pointers (as when providing a selectable pointer for each participating avatar/collaborator) it may be desirable to provide virtual pointers that are visually distinct from one another. This can be accomplished, for example, by providing virtual pointers having different shapes as compared to one another and/or virtual pointers that are visually distinct from one another with respect to color, to note but two examples.

Referring again to FIG. 1, this process 100 then monitors to detect 103 selection of the (or a) three dimensional virtual pointer by a given one of the collaborators. Such detection can be based, for example, upon detecting collaborator manipulation of a user input device such as a cursor control mechanism (including but not limited to such input devices as a mouse, a trackball, a touchpad, voice-controlled cursor control mechanisms, and so forth).

This detection may (though not necessarily) also comprise detecting selection of a particular object as a pointing target. This can be readily accomplished, for example, by adjusting the location of a candidate or selected pointing target as a function, at least in part, of the collaborator's manipulation of a user input device of choice. In a typical application setting, and referring momentarily to FIG. 7, such a user input device can be employed to move a cursor 701 or other selection tool two-dimensionally around the display of the virtual collaboration environment. To potentially render the establishment of the pointing target more convenient or intuitive, if desired, one can employ snap-to methods such that a given object in the virtual collaboration environment is snapped-to as the virtual pointer selection tool of choice moves across the object. Such snap-to mechanisms are well known and understood in the art and require no further description here. Moreover, detecting selection of the object as a pointing target further may include locking a pointing target such that when a source of the three dimensional virtual pointer is moved, the pointing target remains unchanged.

By another approach (either in lieu of the aforementioned technique or as used in selective combination therewith) a user-controllable interface, such as a mouse scroll wheel, can serve to move the selection tool in the Z-plane to various corresponding depths. Such an approach may be particularly useful when working in a virtual collaboration environment that is relatively complicated and/or that features a relatively crowded or object-rich offering. Such movement can be suggested, for example, by increasing or decreasing the size of the object selection tool (such as a cursor) to correspond with movement of the object selection tool towards or away from the viewer, respectively.

Referring again to FIG. 1, this process 100, upon detecting 103 such pointer selection, then displays 104 the selected three dimensional virtual pointer as being sourced by a given one of the plurality of participating avatars as corresponds to the collaborator who selected the virtual pointer and which points to the selected object. To illustrate, and referring momentarily to FIG. 5, the display of the virtual collaboration environment 200 now depicts a virtual pointer 501 as selected by the collaborator who corresponds to the first avatar 202 as being directed from that first avatar 202 to a particular corresponding object 205 that comprises the aforementioned pointing target. So presented, those skilled in the art will see and appreciate that such a virtual pointer 501 intuitively provides a considerable amount of information regarding who is pointing to what.

The particular location from which the virtual pointer 501 appears to be sourced can be fixed or selectable as may be desired. For example, if desired, the collaborator may select a particular source location (either in general or from a plurality of permissible locations). In the example shown the virtual pointer 501 stems from the right hand 502 of the first avatar 202 (to perhaps correspond with the right-handed nature of the collaborator who corresponds to the first avatar 202). This illustration also depicts that the pointing end of the virtual pointer 501 can terminate, if desired, in close proximity to the object. The point of termination can be fixed or can be rendered selectable (either within some permitted range or with complete discretion on the part of the collaborator) depending upon the needs or requirements of a given application setting.

As already described, this virtual collaboration environment 200 comprises a three dimensional construct where each collaborator has a unique view that corresponds to the relative position of its participating avatar. To accommodate this characterizing nature of the virtual collaboration environment 200 the presentation and depiction of such a virtual pointer 501 will also vary with respect to the relative position of the viewer. To illustrate, the view and relative position of the virtual pointer 501 as shown in FIG. 5 corresponds to a view of the fourth avatar (not shown, of course, in FIG. 5).

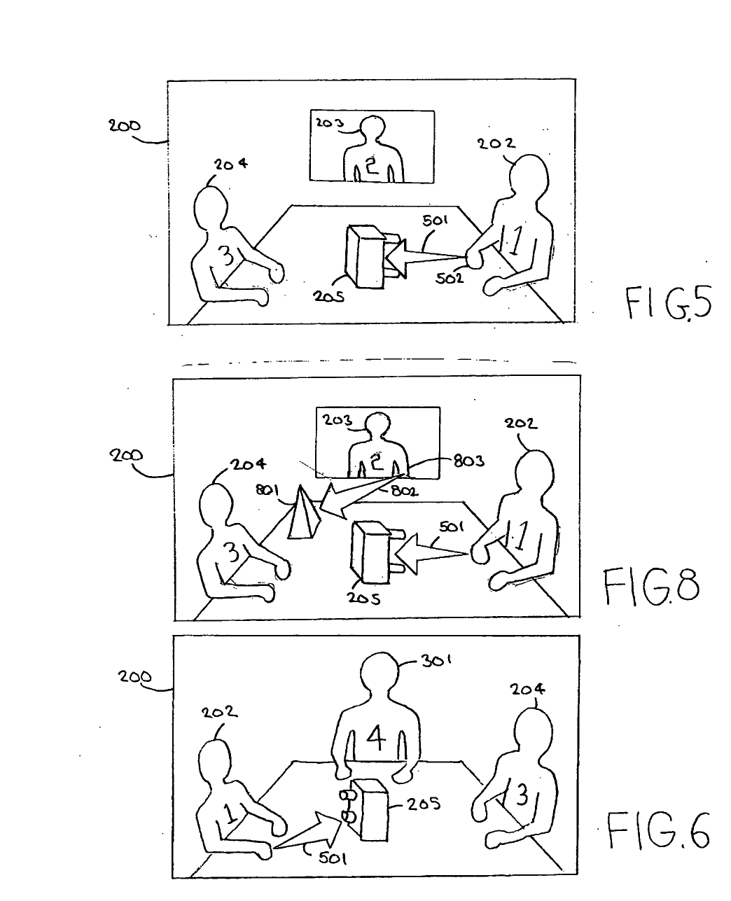

As viewed by another collaborator, however, the view will change. To illustrate further, and referring now to FIG. 6, a view of the virtual collaboration environment 200 by the second avatar will present the virtual pointer 501 on the left side of the display (contrary and opposite to the position shown in FIG. 5). The virtual pointer 501, however, still continues to appear to be sourced from the right hand of the first avatar 202 and continues to point towards the object 205. Accordingly, the virtual pointer 501 is properly viewed as a three dimensional virtual pointer as the relative position and relative orientation of the virtual pointer remains substantially constant within the virtual three dimensional collaboration environment.

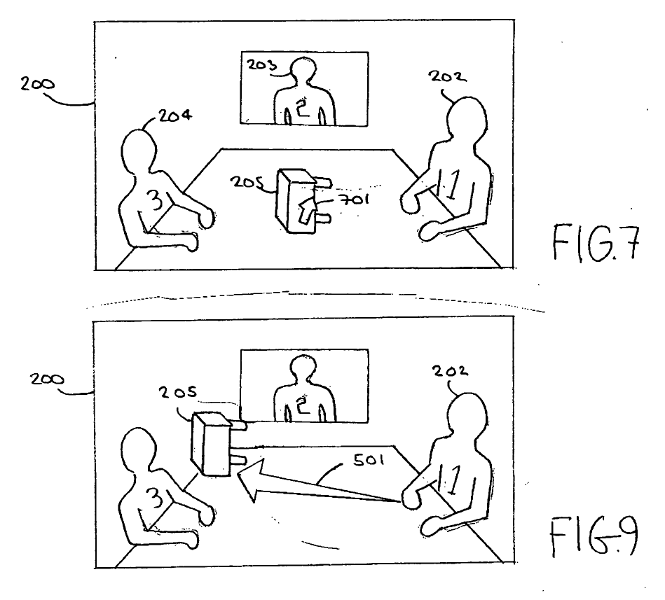

As noted earlier, a plurality of virtual pointers can be provided if desired. In turn, if desired, more than one of the avatars may be allowed to use one or more of these virtual pointers simultaneously with one another. To illustrate, and referring now to FIG. 8, while the first avatar 202 continues to use a first virtual pointer 501 to point to the earlier-mentioned object 205, the collaborator for the second avatar 203 can similarly select its own virtual pointer 802 to selectively point from its (in this example) left hand 803 to a second, different object 801 in the virtual collaboration environment 200. As also noted above, such additional virtual pointers can be visually distinguishable from one another if desired.

By one approach, two or more virtual pointers, when present, are allowed to intersect and pass through one another. By another approach, such an intersection may be prohibited, thereby requiring one of the collaborators to alter its selection criteria in a manner that avoids the objectionable intersection of two or more virtual pointers.

These teachings readily permit collaborators using a virtual collaboration environment to employ one or more virtual pointers to enhance, support, or otherwise facilitate their collaborative discussions with one another. There may be times, however, when a given collaborator may wish to accomplish more than to merely point at a given object. For example, such a collaborator may wish to move a particular object. In such a case, and referring again to FIG. 1, this process 100 will optionally provide for detection 105 of modification of the selectable three dimensional virtual pointer into a virtual object grabber and the subsequent use of that virtual object grabber to move 106 a given object as a function, at least in part, of manipulation of the virtual object grabber. To illustrate, and referring now to FIG. 9, the first collaborator is shown to have used the virtual pointer 501 in this manner to effect movement of the pointed-to object 205 from a first location as shown in FIG. 5 to the location shown in FIG. 9.

Permitting this optional, modified use of the virtual pointer provides a relatively intuitive and simple mechanism to permit a collaborator to move objects within the virtual collaboration environment 200. If desired, the form factor of the virtual pointer can be altered when readied or used as an object grabber. For example, a grasping hand could be depicted instead of the arrow-shaped virtual pointer depicted in FIG. 9.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 10, an illustrative approach to such a platform will now be provided.

This illustrative platform 1000 comprises a display 1001 that couples (for example, via an optional display driver 1002) to a collaborator-selectable three dimensional virtual pointer 1003 and a collaborator interface 1004. In this illustrative embodiment the display 1001 provides a display of a virtual collaboration environment having a plurality of participating avatars that represent the participating collaborators as described above. So configured, the contents of the virtual collaboration environment (including the avatars and objects contained therein) are displayed in respective positions such that each participant viewing the virtual collaboration environment via such a display will view the environment from the unique perspective of its own avatar.

The virtual pointer 1003 can comprise one or more virtual pointers as are described generally or specifically above. The collaborator interface 1004 (which can comprise any presently known or hereafter developed interface of choice) is configured and arranged in this illustrative embodiment to respond to selection of a particular virtual pointer by a given collaborator by facilitating a display of the selected virtual pointer on the display 1001 as being sourced by the corresponding collaborator and which points to a given object which this collaborator has identified to be pointed towards. As noted above, such an interface can comprise a mechanism to adjust the selection of a particular pointing target as a function, at least in part, of collaborator manipulation of the mechanism (with or without snap-to functionality as described above). This interface can also serve, if desired, to facilitate the grabbing functionality described above.

Those skilled in the art will recognize and understand that such an apparatus 1000 may be comprised of a plurality of physically distinct elements as is suggested by the illustration shown in FIG. 10. It is also possible, however, to view this illustration as comprising a logical view, in which case one or more of these elements can be enabled and realized via a shared platform. It will also be understood that such a shared platform may comprise a wholly or at least partially programmable platform as are known in the art.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

We claim:

1. A method for use with a virtual collaboration environment having a plurality of participating avatars representing participants at a plurality of locations with each avatar displayed in its respective environmental perspective and each participant viewing the virtual collaboration environment from a unique perspective of its avatar and at least one object, the method comprising the steps of:
providing a selectable three dimensional virtual pointer;
detecting selection of the selectable three dimensional virtual pointer by a first collaborator;
displaying the selectable three dimensional virtual pointer as being sourced by a given one of the plurality of participating avatars as corresponds to the first collaborator and which points to an object.

2. The method of claim 1 wherein providing a selectable three dimensional virtual pointer comprises providing a plurality of selectable three dimensional virtual pointers.

3. The method of claim 2 wherein the plurality of selectable three dimensional virtual pointers are visually distinct from one another.

4. The method of claim 3 wherein the plurality of selectable three dimensional virtual pointers are visually distinct from one another with respect to color.

5. The method of claim 2 wherein providing a plurality of selectable three dimensional virtual pointers comprises providing at least one selectable three dimensional virtual pointer for each of the plurality of participating avatars.

6. The method of claim 1 wherein the selectable three dimensional virtual pointer has an arrow-shaped form factor.

7. The method of claim 1 wherein detecting selection of the selectable three dimensional virtual pointer by a first collaborator further comprises detecting selection of the object as a pointing target.

8. The method of claim 7 wherein detecting selection of the object as a pointing target further comprises:
detecting collaborator manipulation of a user input device;
adjusting the pointing target as a function, at least in part, of the collaborator manipulation of the user input device.

9. The method of claim 8 wherein adjusting the pointing target comprises adjusting a position of the pointing target within the virtual collaboration environment.

10. The method of claim 7 wherein detecting selection of the object as a pointing target further comprises automatically snapping to the object.

11. The method of claim 10 wherein snapping to the object further comprises following a surface of the object by continuously snapping to the object as the three dimensional virtual pointer is moved across the object.

12. The method of claim 7 wherein detecting selection of the object as a pointing target further comprises locking the pointing target such that when a source of the three dimensional virtual pointer is moved, the pointing target remains unchanged.

13. The method of claim 1 wherein displaying the selectable three dimensional virtual pointer as being sourced by a given one of the plurality of participating avatars as corresponds to the first collaborator and which points to the object further comprises displaying the selectable three dimensional virtual pointer as terminating in close proximity to the object.

14. The method of claim 1 wherein detecting selection of the selectable three dimensional virtual pointer by a first collaborator further comprises detecting selection of a three dimensional virtual pointer source location and wherein displaying the selectable three dimensional virtual pointer as being sourced by a given one of the plurality of participating avatars further comprises displaying the selectable three dimensional virtual pointer as being sourced from the three dimensional virtual pointer source location.

15. The method of claim 1 further comprising:
detecting modification of the selectable three dimensional virtual pointer into a virtual object grabber;
moving the object as a function, at least in part, of manipulation of the virtual object grabber.

16. An apparatus comprising:
a display that provides a display of a virtual collaboration environment having a plurality of participating avatars representing participants at a plurality of locations with each avatar being displayed in its respective environmental perspective and each participant viewing the virtual collaboration environment from a unique perspective of its avatar and at least one object;
a collaborator-selectable three dimensional virtual pointer;
a collaborator interface operably coupled to the display and the collaborator-selectable three dimensional virtual pointer and being configured and arranged to respond to selection of the collaborator-selectable three dimensional virtual pointer by a first collaborator by facilitating the display of the collaborator-selectable three dimensional virtual pointer as being sourced by a given one of the plurality of participating avatars as corresponds to the first collaborator and which points to a given object which the first collaborator has identified to be pointed towards.

17. The apparatus of claim 16 wherein the collaborator-selectable three dimensional virtual pointer comprises a plurality of collaborator-selectable three dimensional virtual pointers.

18. The apparatus of claim 16 wherein the collaborator interface comprises means for detecting selection of the given object as a pointing target.

19. The apparatus of claim 18 wherein the means for detecting selection of the given object as a pointing target further comprises at least one of:
means for adjusting the pointing target as a function, at least in part, of
collaborator manipulation of a user input device; and
means for automatically snapping to the given object.

20. The apparatus of claim 16 further comprising:
means for detecting modification of the selectable three dimensional virtual pointer into a virtual object grabber and for moving the given object as a function, at least in part, of manipulation of the virtual object grabber.
